(19) United States
(12) Patent Application Publication
(10) Pub. No.: US 2007/0220731 A1
(43) Pub. Date: Sep. 27, 2007

(54) Apparatus and method for engaging components through thermal contraction

(75) Inventors: Daniel P. Soroka, Horseheads, NY (US); Richard Kersterke III, Lawrenceville, PA (US); Joseph Colvin, Horseheads, NY (US); Dave Hungerford, Horseheads, NY (US); Craig Carpenter, Pine City, NY (US); Wayne Lewis, Elmira Heights, NY (US)

Correspondence Address: PILLSBURY WINTHROP SHAW PITTMAN, LLP, P.O. BOX 10500, MCLEAN, VA, 22102, US

(73) Assignee: Hardinge, Inc., Elmira, NY (US)

(21) Appl. No.: 11/386,848

(22) Filed: Mar. 23, 2006

(51) Int. Cl. B23P 11/02

(52) U.S. Cl. 29/447; 409/234

(57) ABSTRACT

A bushing has an externally threaded portion with a thread pitch P¹. A collet body has an internally threaded portion with a thread pitch P², which is smaller than P¹ by a pitch differential, ΔP. To assembly the bushing and collet body, the collet body is heated relative to the bushing to reduce the ΔP. The threaded portions of the bushing and collet body are then threadingly engaged with each other. The temperatures of the bushing and collet body are then equalized, which tends to increase the ΔP, which causes the threaded portions to bind with each other and resist relative loosening rotation. The threaded portions may additionally/alternatively be reverse tapered and/or include variable thread pitches that cause the threaded portions to further bind with each other.

### BACKGROUND OF THE INVENTION

1. Field of the Invention

This invention relates generally to methods and devices for engaging components through thermal contraction, and relates specifically to methods and devices for engaging components of a collet assembly.

2. Description of Related Art

Various collets that are used in connection with machines (for example in drills, Bridgeport-type milling machines, lathes, etc.) to clamp objects (e.g., work pieces, tools, probe, measurement device, components to be machined, etc.) include a large diameter central bore with a reduced diameter threaded end for attachment to the machine. See, e.g., U.S. Pat. No. 4,245,846. Such collets may alternatively be used, themselves, as crimping tools. The large diameter central bore and resulting thin wall of the surrounding collet body enable gripping segments/fingers at an opposite end of the collet to flex radially inward and outward to clamp an object. Because it is difficult to machine a large-diameter internal bore with a reduced diameter at each axial end of the bore, manufacturers have conventionally made a large bore in the collet and then added a bushing that reduces the inside diameter of the end of the bore. Manufacturers threadingly engage the bushing to the large bore and rotationally lock the bushing in place by dimpling the outer collet to “stake” the bushing in place. Unfortunately, staking causes the bushing to move out-of-center in a direction opposite to the dimple. Moreover, even with staking, bushings sometimes loosen from the surrounding collet.

It is often desired to prevent two interconnected, threaded components from rotating relative to each other and loosening from each other. Conventional ways to prevent such rotation include using an adhesive such as Loctite™ or staking the components together. Unfortunately, the use of an adhesive is frequently expensive and adds a step to the manufacturing process. As discussed above, staking can cause concentricity problems.

### BRIEF SUMMARY OF THE INVENTION

One aspect of one or more embodiments of the present invention provides a two-piece collet assembly with a threaded mounting portion with an improved concentricity.

Another aspect of one or more embodiments of the present invention provides a two piece collet in which a bushing securely fastens to a surrounding collet body.

Another aspect of one or more embodiments of the present invention provides a method for rotationally locking two threadingly engaged components to each other through thermal contraction.

Another aspect of one or more embodiments of the present invention provides a method of connecting components. The method includes providing a first component having a first threaded portion with a first thread pitch, and providing a second component having a second threaded portion with a second thread pitch. The first thread pitch is different from the second thread pitch when the first and second threaded portions are at a first temperature. The method further includes changing a temperature of at least one of the first and second threaded portions to create a temperature differential between the first threaded portion and the second threaded portion. Changing the temperature causes the first and second thread pitches to become closer to each other. The method further includes threadingly engaging the first and second threaded portions to each other, and equalizing the temperatures of the first and second threaded portions at the first temperature such that the first and second threaded portions bind and discourage relative rotation between the first and second threaded portions.

According to a further aspect of one or more of the above embodiments, the first component comprises a bushing with an internally threaded hole, and the first threaded portion comprises an externally threaded portion of the bushing. The second component comprises a collet body having a rearward mounting portion, a central portion, and a forward portion including a camming surface and a plurality circumferentially spaced gripping segments separated by longitudinal slots in the collet body. A bore extends through the rearward, central, and forward portions. The second threaded portion comprises an internally-threaded portion at the rearward mounting portion of the collet body.

According to a further aspect of one or more of the above embodiments, the temperature differential may be at least 100 degrees Fahrenheit, at least 300 degrees Fahrenheit, or at least 500 degrees Fahrenheit.

According to a further aspect of one or more of the above embodiments, after equalizing of the temperatures of the first and second portions at the first temperature, a resistance of the first and second portions to relative rotation is at least 50% larger than a tightening torque that was applied to threadingly engage the first and second threaded portions to each other after creating the temperature differential. The resistance to relative rotation may be at least twice the tightening torque, or at least 150% larger than the tightening torque.

According to a further aspect of one or more of the above embodiments, the first threaded portion comprises an externally threaded portion with a first pitch diameter that increases toward a forward end of the externally threaded portion. The second threaded portion comprises an internally threaded portion with a second pitch diameter that decreases toward a rearward end of the internally threaded portion. Threadingly engaging the first and second threaded portions to each other comprises threading the forward end of the externally threaded portion into the rearward end of the internally threaded portion such that the forward end is disposed forward of the rearward end. After equalizing the temperatures of the first and second threaded portions at the first temperature, a maximum pitch diameter of the forward end of the externally threaded portion may be larger than a minimum pitch diameter of the rearward end of the internally threaded portion.

According to a further aspect of one or more of the above embodiments, the first thread pitch varies over an axial length of the first threaded portion. The first thread pitch may vary at a constant rate over the entire axial length of the first threaded portion. Alternatively, the first thread pitch may remain constant over a first axial portion of the first threaded portion and vary over a second axial portion of the first threaded portion.

According to a further aspect of one or more of the above embodiments, the first and second threaded portions each comprise substantially square threads.

According to a further aspect of one or more of the above embodiments, the first thread pitch may be at least 0.5% larger than the second thread pitch, or at least 1.0% larger than the second thread pitch.

According to a further aspect of one or more of the above embodiments, threadingly engaging the first and second threaded portions to each other comprises threadingly engaging at least 6 threads.

According to a further aspect of one or more of the above embodiments, threadingly engaging the first and second threaded portions to each other comprises threadingly engaging the first and second threaded portions over at least X threads. The first thread pitch, defined as P¹, is larger than the second thread pitch, defined as P². The following equation is satisfied: (P¹−P²)*X/P²≧0.03. According to further aspects of one or more of these embodiments, (P¹−P²)*X/P² may be equal to or greater than 0.05, 0.07, or 0.09.

Another aspect of one or more embodiments of the present invention provides an assembly that includes a first component having an externally threaded portion with a first thread pitch, P¹. P¹ is defined when the first component is unstressed and at a first temperature. The assembly also includes a second component having an internally threaded portion that threadingly mates with the externally threaded portion over at least X threads. The internally threaded portion has a second thread pitch, P². P² is defined when the second component is unstressed and at the first temperature. P¹ is larger than P². The following equation is satisfied: (P¹−P²)*X/P²≧0.03.

Another aspect of one or more embodiments of the present invention provides a method of connecting components. The method includes providing a first component having an externally threaded portion, and providing a second component having an internally threaded portion. The method further includes changing a temperature of at least one of the internally and externally threaded portions to create a temperature differential between the externally threaded portion and the internally threaded portion. The method further includes threading a forward end of the externally threaded portion into a rearward end of the internally threaded portion such that the forward end is disposed forward of the rearward end. The method further includes equalizing the temperatures of the internally and externally threaded portions. After equalizing the temperatures of the internally and externally threaded portions, a pitch diameter of the externally threaded portion at a first axial position is larger than a pitch diameter of the internally threaded portion at a second axial position rearward of the first axial position.

According to a further aspect of one or more of these embodiments, a maximum pitch diameter of the forward portion of the externally threaded portion is larger than a minimum pitch diameter of the internally threaded portion rearward of the forward portion. The maximum pitch diameter may exceed the minimum pitch diameter by at least 0.1% of the minimum pitch diameter, by at least 0.3% of the minimum pitch diameter, or by at least 1.0% of the minimum pitch diameter.

According to a further aspect of one or more of the above embodiments, the externally threaded portion has a first variable pitch diameter that increases toward the forward portion of the externally threaded portion, and the internally threaded portion has a second variable pitch diameter that decreases toward the rearward portion of the internally threaded portion.

According to a further aspect of one or more of the above embodiments, the first component comprises a bushing with an internally threaded hole, and the second component comprises a collet body having a rearward mounting portion, a central portion, a forward portion including a camming surface and a plurality circumferentially spaced gripping segments separated by longitudinal slots in the collet body, and a bore extending through the rearward, central, and forward portions of the collet body. The internally threaded portion is disposed at the rearward mounting portion of the collet body.

Another aspect of one or more embodiments of the present invention provides an assembly made in accordance with one or more of these methods.

Additional and/or alternative advantages and salient features of the invention will become apparent from the following detailed description and claims, which, taken in conjunction with the annexed drawings, disclose preferred embodiments of the invention.

### BRIEF DESCRIPTION OF THE DRAWINGS

Referring now to the drawings which form a part of this original disclosure:

FIG. 1 is a partially cut-away side view of a collet assembly according to an embodiment of the present invention;

FIG. 2 is a cross-sectional perspective view of the collet assembly in FIG. 1;

FIG. 3 is a detailed cross-sectional view of the collet assembly in FIG. 1; and

FIG. 4 is a partially cut-away side view of a collet assembly according to an alternative embodiment of the present invention.

The foregoing description is included to illustrate the operation of the preferred embodiments and is not meant to limit the scope of the invention. To the contrary, those skilled in the art should appreciate that varieties may be constructed and employed without departing from the scope of the invention, aspects of which are recited by the claims appended hereto.

### DETAILED DESCRIPTION OF EMBODIMENTS OF THE INVENTION

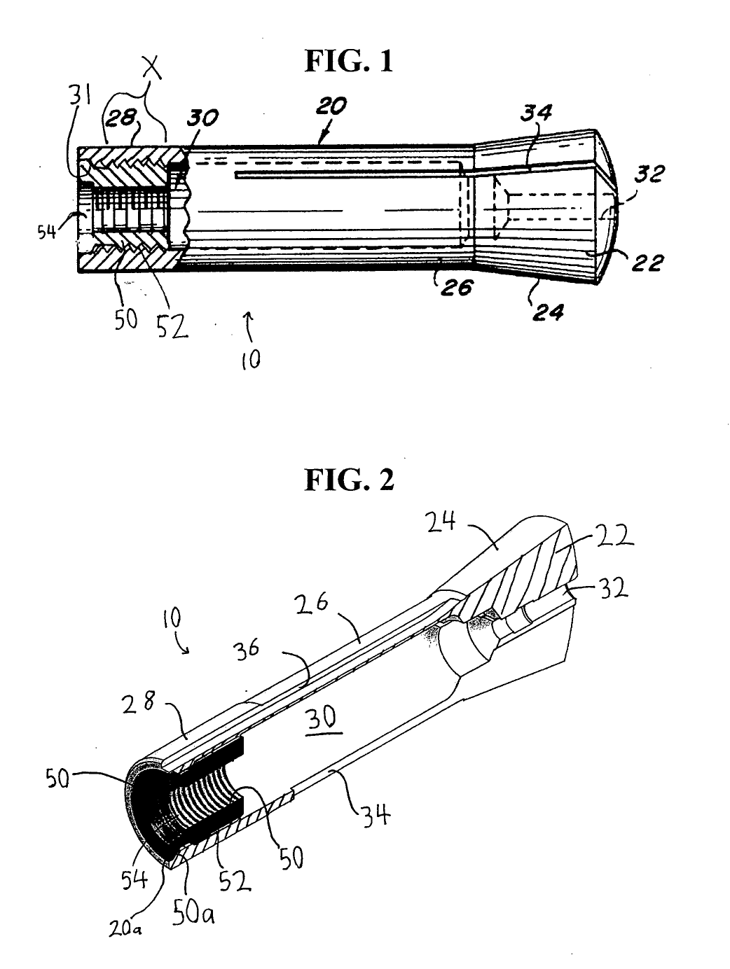

As shown in FIGS. 1-3, a collet assembly 10 includes a collet body 20 and a bushing 50.

The collet body 20 is generally cylindrical and includes a front object-gripping portion 22, the outer surface 24 of which is generally frusto-conical to provide a camming surface for cammed interaction with the clamping device. The collet body 20 further includes a central spring leaf portion 26 and a rearward mounting portion 28. A longitudinal bore 30 extends through the rear portion 28 and the central spring leaf portion 26. The rearward portion 28 includes an internally threaded portion 31. A longitudinal bore 32 of reduced diameter relative to the bore 30 extends axially through the forward portion 22 and is constructed to accommodate an object being disposed therein. A plurality of longitudinal slots 34 extend radially outwardly from bores 30 and 32 to the outer periphery of the collet body 20. The slots 34 extend through the forward portion 24 and at least part of the central portion 26, thereby defining a plurality of resilient, circumferentially spaced gripping fingers or segments. The reduced thickness of the central leaf spring portion 26 enables the fingers to flex radially inward when the gripping portion 22 is urged inwardly. Conversely, the leaf spring portion 26 resiliently urges the fingers radially outwardly when the gripping portion 22 is not urged inwardly.

As shown in FIG. 2, a longitudinal keyway 36 extends along the outer surface of the rear and central portions 28, 26. The keyway 36 mates with a key of the clamping machine to prevent the collet body 20 from rotating while connected to the clamping machine.

The bushing 50 includes an externally threaded portion 52 that threadingly engages the internally threaded portion 31 of the collet body 20. The bushing 50 includes a threaded bore 54 that is constructed and arranged to attach to the clamping machine.

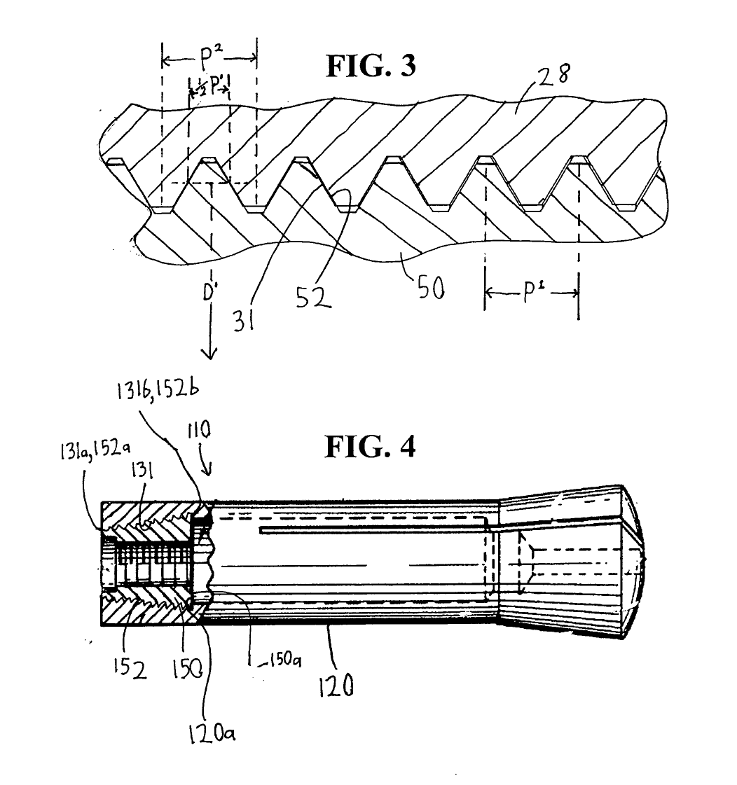

As shown in FIG. 3, the externally threaded portion 52 of the bushing 50 is constructed to have a thread pitch P¹ when the bushing 50 is at a first temperature, e.g., room temperature. The internally threaded portion 31 is constructed to have a thread pitch P² when the collet body 20 is at the first temperature. P¹ is larger than P² by a pitch differential, ΔP, i.e., (P¹−P²). According to various embodiments, ΔP may be at least 0.25% of P², at least 0.5% of P², at least 1.0% of P², or between 0.1% and 5.0% of P². In one embodiment, P¹ is 0.0633 inches (i.e., a lead of 15.8 threads/inch), while P² is 0.0625 inches (i.e., a lead of 16 threads/inch), such that ΔP is 0.0008 inches (1.25% of P²). The ΔP is preferably set such that it is very difficult to threadingly engage the threaded portions 31, 52 by more than a thread or two when the threaded portions 31, 52 are at the same temperature.

Hereinafter, assembly of the bushing 50 and collet body 20 is described with reference to FIGS. 1-3. The collet body 20 is heated relative to the bushing 50 to create a predetermined temperature differential, ΔT, between the collet body 20 and the bushing 50. Alternatively and/or additionally, the bushing 50 may be cooled to achieve the desired ΔT. According to various embodiments, ΔT may be at least 100 degrees Fahrenheit, at least 200 degrees Fahrenheit, at least 300 degrees Fahrenheit, or at least 500 degrees Fahrenheit. According to one embodiment of the present invention, ΔT is about 600 degrees Fahrenheit. The ΔT results in thermal expansion of the heated collet body 20 (and/or thermal contraction of the cooled bushing 50), which reduces the ΔP. With the reduced ΔP, the threaded portions 31, 52 are threadingly engaged with each other. The threaded portions 31, 52 are preferably threaded to each other over at least X number of threads. According to various embodiments of the present invention, X is at least 4 threads, at least 5 threads, at least 6 threads, at least 7 threads, at least 8 threads, at least 9 threads, at least 10 threads, or at least 11 threads. According to one embodiment of the present invention, X is 12 threads.

After threadingly engaging the bushing 50 and collet body 20, the temperatures of the bushing 50 and collet body 20 are equalized at the first temperature. Thermal contraction of the collet body 20 relative to the bushing 50 tends to increase the ΔP, which causes the threads of the threaded portions 31, 52 to bind and possibly elastically deform to some extent, which tends to rotationally bind the bushing 50 to the collet body 20. The ΔP and X are preferably set so as to avoid plastic deformation of the threaded portions 31, 52 as the temperatures of the threaded portions 31, 52 equalize. Alternatively, plastic deformation may be intentionally induced during equalization of the temperatures of the threaded portions 31, 52 to further bind the portions 31, 52 together.

The collet body 20 preferably includes a shoulder that prevents the bushing 50 from moving forwardly relative to the collet body 20 beyond a predetermined axial position. As shown in FIG. 2, the rearward end of the bushing 50 includes a frusta-conical surface/shoulder 50a that abuts a corresponding frusta-conical surface 20a of the collet body 20. Engagement of the frusta-conical sections 50a, 20a of the bushing 50 and collet body 20 centers the bushing 50 in the collet body 20 and prevents further forward movement of the bushing 50 relative to the collet body 20. Alternatively, the shoulder in the collet body 20 may be defined by a forward extent of the internally threaded portion 31. The shoulder may alternatively be defined forward of the threaded portion 31. For example, the shoulder may be defined by the intersection between the bores 30, 32. The shoulders may alternatively be omitted without deviating from the scope of the present invention.

The binding tends to discourage relative rotation between the threaded portions 31, 52. In one embodiment, a torque required to loosen the threaded portions 31, 52 from each other (i.e., a resistance to relative loosening rotation or a binding torque) after equalizing the temperatures is at least 50% larger than a tightening torque that was applied to threadingly engage the threaded portions 31, 52 to each other after creating the ΔT. According to another embodiment, the resistance to relative loosening is at least twice the tightening torque. According to another embodiment, the resistance to relative loosening is at least 150% larger than the tightening torque. According to another embodiment, the resistance to relative loosening is about three times the tightening torque. In one embodiment, 50 ft-lbs. of torque is required to threadingly engage the bushing 50 and collet body 20. After equalizing the temperatures, the binding torque is approximately 150 ft-lbs.

The binding that occurs when the threaded portions 31, 52 equalize in temperature tends to keep the bushing 50 concentric with the collet body 20. This may be due in part to the interacting angles of the binding threads of the threaded portions 31, 52.

The ΔT, ΔP, and X may be optimized for use with specific types of materials with specific thermal expansion properties and required resistances to loosening rotation. According to one embodiment, the bushing 50 and collet body 20 are both steel, which has a coefficient of thermal expansion of 6.5×10⁻⁶/degree Fahrenheit. According to another embodiment, the bushing 50 and collet body 20 comprise different materials with different coefficients of thermal expansion. According to a further embodiment, the coefficients of thermal expansion of the bushing 50 and collet body 20 are so different that the ΔP may be sufficiently reduced by sufficiently raising (or lowering) the temperature of both components 20, 50 to the same extent.

According to one embodiment of the present invention, the cumulative thread shift over the engaged length of the threaded portions 31, 52 is at least 3% of P²:
ΔP*X/P²≧0.03
The cumulative thread shift may be at least 5%, at least 7%, at least 8%, at least 9%, at least 10%, at least 11%, at least 12%, or at least 14% of P². According to one embodiment of the present invention, the cumulative thread shift is about 15.4% of P².

The collet assembly 10 illustrated in FIGS. 1 and 2 relies on mismatched pitch threads and axial thermal expansion and contraction to create the binding forces between the bushing 50 and 20. The radial forces, which cause hoop stress in the collet body 20 are preferably minimized to limit stress that might develop at the reduced thickness portion of the collet body 20 at the keyway 36. Such hoop stresses may also deform the collet body 20, thereby causing the collet body 20 to become out of round. To reduce the hoop stress, the pitch diameter (i.e., the diameter of the threaded portion at an axial point of the thread surface where the thread's width in the axial direction equals ½ of the thread pitch) of the internally threaded portion 31 may be increased relative to the pitch diameter of the externally threaded portion 52. The pitch diameter D¹ of the externally threaded portion 52 is illustrated in FIG. 3. Such a pitch diameter differential provides additional tolerance so as to reduce hoop stresses that might result from the radial contraction of the cooling collet body 20. The hoop stresses may also be reduced by reducing the outside diameter of the externally threaded portion 52 (i.e., flattening/truncating the radial outer extremities of the threads) and/or increasing the inner diameter of the internally threaded portion 32. To reduce hoop stresses that might result from axial expansion and contraction, which converts into radial expansion/contraction via interaction between the angled teeth (typically an angle of 60 degrees relative to a longitudinal axis) of the threaded portions 31, 52, the threaded portions 31, 52 may utilize square teeth (i.e., teeth that form a 90 degree angle with the longitudinal axis) that cause no radially-oriented forces. Alternatively, the threads may be disposed at an angle greater than 60 degrees and less than 90 degrees relative to a longitudinal axis so as to reduce the radial portion of the forces exerted by the threads.

The threaded portions 31, 52 may utilize any suitable type of thread (e.g., square threads, buttress threads, standard machine threads, or any other of the full range of common thread forms).

In the illustrated embodiment, radial forces and hoop stresses are preferably minimized to reduce stress at the keyway 36. However, according to an alternative embodiment of the present invention, radial thermal expansion/contraction is utilized in addition to and/or as an alternative to axial expansion to bind the threaded portions 31, 52 to each other. In such an embodiment, the pitch diameters of the internally and externally threaded portions 31, 52 may be interfering when the bushing 50 and collet body 20 are at the first temperature. When the collet body 20 is heated to create the ΔT, the pitch diameter of the internally threaded portion 31 increases, which allows the threaded portions 31, 52 to be threaded to each other. When the temperatures of the bushing 50 and collet body 20 equalize, the collet body 20 contracts, which creates radial and hoop forces that tend to bind the threaded portions 31, 52 to each other.

FIG. 4 illustrates a collet assembly 110 according to an alternative embodiment of the present invention. The collet assembly 110 includes a collet body 120 and a bushing 150. The collet body 120 and bushing 150 are generally similar to the collet body 20 and bushing 50 illustrated in FIGS. 1-3. However, an internally threaded portion 131 of the collet body 120 and an externally threaded portion 152 of the bushing 150 are differently shaped than the threaded portions 31, 52 of the collet assembly 10. In particular, the threaded portions 131, 152 each include a reverse taper, which is shown in exaggerated form in FIG. 4. A pitch diameter of the externally threaded portion 152 of the bushing 150 increases from a rearward end 152a of the externally threaded portion 152 to a forward end 152b of the externally threaded portion 152. Similarly, a pitch diameter of the internally threaded portion 131 of the collet body 120 increases from a rearward end 131a of the threaded portion 131 to a forward end 131b of the threaded portion 131. When the bushing 150 and collet body 120 are at a first temperature, e.g., room temperature, the pitch diameter at the forward end 152b of the externally threaded portion 152 is larger than the pitch diameter at the rearward end 131a of the internally threaded portion 131. Accordingly, there would be an interference fit between the threaded portions 131, 152 if the forward end 152b of the externally threaded portion 152 were threaded into the rearward end 131a of the internally threaded portion 131. According to an embodiment of the present invention, a maximum pitch diameter of a forward portion of the externally threaded portion 152 exceeds a minimum pitch diameter of the portion of the internally threaded portion 131 disposed rearwardly of the forward portion by at least 0.1% of the minimum pitch diameter. The maximum pitch diameter may exceed the minimum pitch diameter by at least 0.2% of the minimum pitch diameter, by at least 0.3% of the minimum pitch diameter, by at least 0.4% of the minimum pitch diameter, by at least 0.5% of the minimum pitch diameter, by at least 0.6% of the minimum pitch diameter, by at least 0.7% of the minimum pitch diameter, by at least 0.8% of the minimum pitch diameter, by at least 0.9% of the minimum pitch diameter, or by at least 1.0% of the minimum pitch diameter. Consequently, a pitch diameter of the externally threaded portion 152 at a first axial position is larger than a pitch diameter of the internally threaded portion 131 at a second axial position rearward of the first axial position.

To assemble the collet assembly 10, the collet body 120 is heated relative to the bushing 150 to create the ΔT. Thermal expansion of the collet body 120 reduces or eliminates the interference between the pitch diameters of the forward end 152b and the rearward end 131a. The forward end 152b of the bushing 150 is then threaded into the rearward end 131a of the collet body 120 and the temperatures are equalized. The reverse taper of the threaded portions 152, 131 discourages the bushing 150 and collet body 120 from rotationally loosening from each other. A rearwardly facing shoulder 120a in the collet body 120 may abut a forward facing shoulder 150a of the bushing 150 when the bushing 150 is threaded into the collet body 120. The abutment between the shoulders 120a, 150a may discourage the bushing 150 from threading further into the collet body 120 and may provide additional resistance to relative rotation between the collet body 120 and bushing 150.

In the illustrated embodiment, the pitch diameters of the threaded portions 131, 152 vary at a constant rate such that they are frusto-conical. However, the pitch diameters may alternatively vary at varying rates without deviating from the scope of the present invention. For example, the threaded portions 131, 152 may include mating constant pitch diameter portions and mating variable pitch diameter portions. Alternatively, the pitch diameters may vary at a progressively increasing and/or decreasing rate without deviating from the scope of the present invention.

In the illustrated embodiments, the thread pitches of the bushings and collet bodies are constant. However, according to an alternative embodiment of the present invention, the thread pitches vary over the axial length of the threaded portions. Such thread pitch changes may be used to accommodate various static and dynamic effects. For example, if the collet body 20 is extremely long, it may be easier to only heat the rearward portion 28 of the collet body 20. The central and forward portions 26, 24 therefore act as heat sinks that tend to cool down the forward end of the threaded portion 31 before the bushing 50 is completely threaded into the collet body 50. Accordingly, the thread pitch of the forward end of the threaded portion 31 may be increased relative to the rearward end to account for the reduced thermal expansion that will occur due to the reduced temperature gradient at the forward end of the internally threaded portion.

Similarly, a thread pitch at the forward end of the externally threaded portion 52 of the bushing 50 may be decreased relative to a rearward end of the externally threaded portion 52. Such a pitch difference may account for thermal expansion that will occur toward the forward end of the bushing 50 as the bushing 50 is threaded into the collet body 20 and absorbs some of the heat from the surrounding collet body 20. The threaded portions 31, 52 may include a combination of constant thread pitch portions and variable thread pitch portions.

Variable thread pitches may also be used to control where binding forces are focused along the axial extent of the threaded connection. For example, the ΔP may be limited at a weaker area of the bushing or collet body, while the ΔP may be augmented at a thicker area of the bushing and collet body.

In the illustrated embodiments, the internally threaded collet body is heated relative to the externally threaded bushing. Consequently, heating the collet body increases an internal diameter of the collet body, which makes it easier to assemble the bushing and collet body. According to an alternative embodiment of the present invention, however, the externally threaded bushing is heated relative to the internally threaded collet body. In various embodiments, it may be easier to heat (or cool) the externally threaded portion than it is to heat (or cool) the internally threaded portion. The pitch diameters and thread pitches of the components may be specifically designed to accommodate the heating or cooling of either component.

The foregoing embodiments illustrate various ways that thermal expansion/contraction may be used to increase a resistance to rotation between a bushing and a collet body. Any two or more of the above ways may be combined to create further resistance to relative rotation between a bushing and a collet body without deviating from the scope of the present invention.

The foregoing embodiments illustrate how embodiments of the present invention may be used to connect a bushing to a collet body. However, one or more embodiments of the present invention may alternatively be used to connect various other types of threaded components. For example, the present invention may be used to secure a nut to a bolt, secure two sections of pipe together, etc. without deviating from the scope of the present invention.

The foregoing description is included to illustrate the operation of the preferred embodiments and is not meant to limit the scope of the invention. To the contrary, those skilled in the art should appreciate that varieties may be constructed and employed without departing from the scope of the invention, aspects of which are recited by the claims appended hereto.

What is claimed is:

1. A method of connecting components, comprising:
providing a first component having a first threaded portion with a first thread pitch;
providing a second component having a second threaded portion with a second thread pitch, the first thread pitch being different from the second thread pitch when the first and second threaded portions are at a first temperature;
changing a temperature of at least one of the first and second threaded portions to create a temperature differential between the first threaded portion and the second threaded portion, wherein changing the temperature causes the first and second thread pitches to become closer to each other;
threadingly engaging the first and second threaded portions to each other; and
equalizing the temperatures of the first and second threaded portions at the first temperature such that the first and second threaded portions bind and discourage relative rotation between the first and second threaded portions.

2. The method of claim 1, wherein:
the first component comprises a bushing with an internally threaded hole;
the first threaded portion comprises an externally threaded portion of the bushing;
the second component comprises a collet body having
a rearward mounting portion,
a central portion,
a forward portion including a camming surface and a plurality circumferentially spaced gripping segments separated by longitudinal slots in the collet body, and
a bore extending through the rearward, central, and forward portions; and
the second threaded portion comprises an internally-threaded portion at the rearward mounting portion of the collet body.

3. The method of claim 1, wherein the temperature differential is at least 300 degrees Fahrenheit.

4. The method of claim 1, wherein, after the equalizing of the temperatures of the first and second portions at the first temperature, a resistance of the first and second portions to relative rotation is at least 50% larger than a tightening torque that was applied to threadingly engage the first and second threaded portions to each other after creating the temperature differential.

5. The method of claim 4, wherein the resistance to relative rotation is at least twice the tightening torque.

6. The method of claim 1, wherein:
the first threaded portion comprises an externally threaded portion with a first pitch diameter that increases toward a forward end of the externally threaded portion;
the second threaded portion comprises an internally threaded portion with a second pitch diameter that decreases toward a rearward end of the internally threaded portion;
threadingly engaging the first and second threaded portions to each other comprises threading the forward end of the externally threaded portion into the rearward end of the internally threaded portion such that the forward end is disposed forward of the rearward end.

7. The method of claim 1, wherein, after equalizing the temperatures of the first and second threaded portions at the first temperature, a pitch diameter of the externally threaded portion at a first axial position is larger than a pitch diameter of the internally threaded portion at a second axial position rearward of the first axial position.

8. The method of claim 1, wherein the first thread pitch varies over an axial length of the first threaded portion.

9. The method of claim 8, wherein the first thread pitch varies at a constant rate over the entire axial length of the first threaded portion.

10. The method of claim 8, wherein the first thread pitch remains constant over a first axial portion of the first threaded portion and varies over a second axial portion of the first threaded portion.

11. The method of claim 1, wherein the first and second threaded portions each comprise substantially square threads.

12. The method of claim 1, wherein the first thread pitch is at least 0.5% larger than the second thread pitch.

13. The method of claim 1, wherein the first thread pitch is at least 1.0% larger than the second thread pitch.

14. The method of claim 1, wherein threadingly engaging the first and second threaded portions to each other comprises threadingly engaging at least 6 threads.

15. The method of claim 1, wherein:
threadingly engaging the first and second threaded portions to each other comprises threadingly engaging the first and second threaded portions over at least X threads;
the first thread pitch, defined as P¹, is larger than the second thread pitch, defined as P²; and
(P¹−P²)*X/P²≧0.03.

16. The method of claim 15, wherein: (P¹−P²)*X/P²≧0.05.

17. The method of claim 16, wherein: (P¹−P²)*X/P²≧0.07.

18. The method of claim 17, wherein: (P¹−P²)*X/P²≧0.09.

19. An assembly comprising:
a first component having an externally threaded portion, the externally threaded portion having a first thread pitch, P¹, P¹ being defined when the first component is unstressed and at a first temperature; and
a second component having an internally threaded portion that threadingly mates with the externally threaded portion over at least X threads, the internally threaded portion having a second thread pitch, P², P² being defined when the second component is unstressed and at the first temperature,
wherein P¹ is larger than P², and
wherein (P¹−P²)*X/P²≧0.03.

20. The assembly of claim 19, wherein:
the first component comprises a bushing with an internally threaded hole; and
the second component comprises a collet body having
a rearward mounting portion,
a central portion,
a forward portion including a camming surface and a plurality circumferentially spaced gripping segments separated by longitudinal slots in the collet body, and
a bore extending through the rearward, central, and forward portions; and
the second threaded portion is disposed at the rearward mounting portion of the collet body.

21. A method of connecting components, comprising:
providing a first component having an externally threaded portion;
providing a second component having an internally threaded portion;
changing a temperature of at least one of the internally and externally threaded portions to create a temperature differential between the externally threaded portion and the internally threaded portion;
threading a forward portion of the externally threaded portion into a rearward portion of the internally threaded portion such that the forward portion is disposed forward of the rearward portion; and
equalizing the temperatures of the internally and externally threaded portions,
wherein after equalizing the temperatures of the internally and externally threaded portions, a pitch diameter of the externally threaded portion at a first axial position is larger than a pitch diameter of the internally threaded portion at a second axial position rearward of the first axial position.

22. The method of claim 21, wherein a maximum pitch diameter of the forward portion of the externally threaded portion exceeds a minimum pitch diameter of the internally threaded portion rearward of the forward portion by at least 0.1% of the minimum pitch diameter.

23. The method of claim 22, wherein the maximum pitch diameter exceeds the minimum pitch diameter by at least 0.3% of the minimum pitch diameter.

24. The method of claim 23, wherein the maximum pitch diameter exceeds the minimum pitch diameter by at least 1.0% of the minimum pitch diameter.

25. The method of claim 21, wherein:
the externally threaded portion has a first variable pitch diameter that increases toward the forward portion of the externally threaded portion; and
the internally threaded portion has a second variable pitch diameter that decreases toward the rearward portion of the internally threaded portion.

26. The method of claim 25, wherein:
the first component comprises a bushing with an internally threaded hole; and
the second component comprises a collet body having
a rearward mounting portion,
a central portion,
a forward portion including a camming surface and a plurality circumferentially spaced gripping segments separated by longitudinal slots in the collet body, and
a bore extending through the rearward, central, and forward portions of the collet body; and
the internally threaded portion is disposed at the rearward mounting portion of the collet body.

27. An assembly comprising:
a first component having an externally threaded portion with a first pitch diameter that increases toward a forward portion of the externally threaded portion; and
a second component having an internally threaded portion with a second pitch diameter that decreases toward a rearward portion of the internally threaded portion, wherein the forward portion of the externally threaded portion is threaded into the rearward portion of the internally threaded portion such that the forward portion is disposed forward of the rearward portion,
wherein a pitch diameter of the externally threaded portion at a first axial position is larger than a pitch diameter of the internally threaded portion at a second axial position rearward of the first axial position.

28. The assembly of claim 27, wherein the second component further comprises a shoulder that prevents the first component from moving forwardly relative to the second component beyond a predetermined axial position.

29. The assembly of claim 27, wherein:
the externally threaded portion has a first variable pitch diameter that increases toward the forward portion of the externally threaded portion; and
the internally threaded portion has a second variable pitch diameter that decreases toward the rearward portion of the internally threaded portion.

30. The assembly of claim 29, wherein:
the first component comprises a bushing with an internally threaded hole; and
the second component comprises a collet body having
a rearward mounting portion,
a central portion,
a forward portion including a camming surface and a plurality circumferentially spaced gripping segments separated by longitudinal slots in the collet body, and
a bore extending through the rearward, central, and forward portions of the collet body; and
the second threaded portion is disposed at the rearward mounting portion of the collet body.
